(19) United States
(12) Patent Application Publication
(10) Pub. No.: US 2009/0160774 A1
(43) Pub. Date: Jun. 25, 2009

(54) DISPLACEMENT DETECTION APPARATUS AND METHOD

(75) Inventors: Chin Chou LEE, Science-Based Industrial Park Hsin-Chu (TW); Hsin Chia Chen, Science-Based Industrial Park Hsin-Chu (TW)

Correspondence Address: LOWE HAUPTMAN HAM & BERNER, LLP, 1700 DIAGONAL ROAD, SUITE 300, ALEXANDRIA, VA, 22314, US

(73) Assignee: PIXART IMAGING INC., Science-Based Industrial Park Hsin-Chu (TW)

(21) Appl. No.: 12/258,258

(22) Filed: Oct. 24, 2008

(30) Foreign Application Priority Data
Dec. 21, 2007 (TW) 096149148

(51) Int. Cl. G09G 5/08

(52) U.S. Cl. 345/166

(57) ABSTRACT

A displacement detection method includes the steps of: capturing a first image and a second image, and obtaining a displacement variation according to the first and the second images; comparing the displacement variation with at least one threshold value; and adaptively adjusting a displacement sensitivity outputted from a displacement detection apparatus according a comparison result of comparing the displacement variation with the threshold value. The present invention further provides a displacement detection apparatus.

### CROSS REFERENCE TO RELATED APPLICATION

This application claims the priority benefit of Taiwan Patent Application Serial Number 096149148, filed on Dec. 21, 2007, the full disclosure of which is incorporated herein by reference.

### BACKGROUND OF THE INVENTION

1. Field of the Invention

This invention generally relates to a displacement detection apparatus and method, and more particularly, to a displacement detection apparatus with adaptively adjustable displacement sensitivity and a method for adaptively adjusting the displacement sensitivity of a displacement detection apparatus.

2. Description of the Related Art

Conventional displacement detection apparatus, such as a mouse or a pointer positioning device, transmits detected displacements to an image display device, e.g. a projection device, a game machine, a personal computer and a television, so as to accordingly control the movement of a cursor or an aiming point shown on the screen of the image display device. In the conventional displacement detection apparatus, detected displacements normally have a fixed predetermined relationship with respect to the movement of a cursor or an aiming point, called counts per inch (CPI) or counts per millimeter. For example, a displacement detection apparatus with 800 CPI displacement sensitivity (or space resolution) means that a displacement variation detected by a displacement detection apparatus for moving one inch corresponds to 800 pixels movement of a cursor or an aiming point shown on the image display device.

However in some circumstances, fixed displacement sensitivity may not be able to fulfill the requirements of users. For instance, when a user controls the cursor or the aiming point to perform a drawing program requiring fine movement of the cursor or the aiming point, it is difficult to perform a tiny movement within high displacement sensitivity. On the contrary, when a user controls the cursor or the aiming point to perform a game program, it may need higher displacement sensitivity so as to increase the operating smoothness of the game. In this manner, the field of art proposed displacement detection apparatuses with adjustable displacement sensitivity. However, in most proposed displacement detection apparatuses, adjustment of the displacement sensitivity needs to be operated manually and a user may not be able to adjust the displacement sensitivity to achieve a desired sensitivity quickly.

In U.S. Pat. No. 7,161,585, entitled “Displacement data post-processing and reporting in an optical pointing device”, a method of processing and reporting detected displacement in an optical pointing device was disclosed. The method includes the steps of: detecting the displacement and accumulating a first count representative of a magnitude of the detected displacement in an associated accumulation unit, the first count representing the magnitude of the detected displacement at a first resolution (step a); processing the first count accumulated in the accumulation unit to convert this first count into a report count representing the magnitude of the detected displacement at a second resolution lower than the first resolution (step b); reporting the report count to a PC or an external controller (step c); and repeating steps a to c, wherein the second resolution is selectable between at least two predetermined resolutions including a low reporting resolution and a high reporting resolution, and wherein the report count is reported at a selected reporting rate, the value of the reporting rate being decreased when switching from the high reporting resolution to the low reporting resolution and increased when switching from the low reporting resolution to the high reporting resolution. However, this method can not automatically adjust the displacement sensitivity outputted from the optical pointing device directly according to the detected displacement; therefore it still can not fulfill the requirements of various users.

The present invention provides a displacement detection apparatus and method which can automatically and real-timely perform the adjustment of the displacement sensitivity during operation according to a detected displacement variation so as to increase the operating convenience and the practicability of a displacement detection apparatus.

### SUMMARY OF THE INVENTION

It is an object of the present invention to provide a displacement detection apparatus and method, wherein the displacement sensitivity/resolution can be real-timely and automatically adjusted according to a detected displacement variation so as to improve the operational accuracy.

It is another object of the present invention to provide a displacement detection apparatus and method, wherein a displacement sensitivity/resolution outputted by the displacement detection apparatus can be larger than, equal to or smaller than a detected displacement sensitivity/resolution so as to increase the practicability of the displacement detection apparatus and method.

In order to achieve above objects, the present invention provides a displacement detection method including the steps of: capturing a first image and a second image, and obtaining a displacement variation according to the first and the second images; comparing the displacement variation with at least one threshold value; and adaptively adjusting a displacement sensitivity outputted from a displacement detection apparatus according to a comparison result of comparing the displacement variation and the threshold value.

According to another aspect of the present invention, the present invention further provides a displacement detection method for adaptively adjusting a displacement sensitivity outputted from a displacement detection apparatus. The displacement detection method includes the steps of: providing a lookup table representing the relationship between a plurality of threshold values and the displacement sensitivity to be outputted from the displacement detection apparatus; capturing a first image and a second image, and obtaining a displacement variation according to the first and the second images; and comparing the displacement variation with the lookup table to adaptively adjust the displacement sensitivity outputted from the displacement detection apparatus.

The present invention further provides a displacement detection apparatus including an image capturing unit, a storage unit, a sensitivity control unit and a processing unit. The image capturing unit is for capturing a first image and a second image, and for obtaining a displacement variation according to the first and the second images. The storage unit stores at least one threshold value. The sensitivity control unit is for adjusting a displacement sensitivity outputted from the displacement detection apparatus. The processing unit compares the displacement variation with the threshold value and adaptively controls the sensitivity control unit to adjust the displacement sensitivity outputted from the displacement detection apparatus according to a comparison result of comparing the displacement variation with the threshold value.

The displacement detection method of the present invention can be adapted to a displacement detection apparatus, such as an optical mouse or a pointing device. The present displacement detection method can adaptively adjust a displacement sensitivity outputted from a displacement detection apparatus according to a detected displacement variation, and can electrically or wirelessly transmit the displacement sensitivity through a transmission interface unit to an image display device, such as a television, a computer screen, a game machine screen or a projection screen, so as to accordingly control the movement of a cursor or an aiming point on the screen according to different displacement sensitivity.

### BRIEF DESCRIPTION OF THE DRAWINGS

Other objects, advantages, and novel features of the present invention will become more apparent from the following detailed description when taken in conjunction with the accompanying drawings.

FIG. 1a shows a schematic diagram of the displacement detection apparatus according to an embodiment of the present invention.

FIG. 1b shows a block diagram of the displacement detection apparatus according to an embodiment of the present invention.

FIG. 2a shows a schematic diagram of the setting of displacement sensitivities with respect to threshold values in the displacement detection apparatus according to an embodiment of the present invention.

FIG. 2b shows another schematic diagram of the setting of displacement sensitivities with respect to threshold values in the displacement detection apparatus according to an embodiment of the present invention.

FIG. 3a shows a relationship diagram of displacement sensitivities with respect to a plurality of threshold values in the displacement detection apparatus according to an embodiment of the present invention.

FIG. 3b shows another relationship diagram of displacement sensitivities with respect to a plurality of threshold values in the displacement detection apparatus according to an embodiment of the present invention.

FIG. 4 shows a flow chart diagram of the displacement detection method according to an embodiment of the present invention.

FIG. 5 shows a schematic diagram of the displacement detection apparatus according to an alternative embodiment of the present invention.

### DETAILED DESCRIPTION OF THE PREFERRED EMBODIMENT

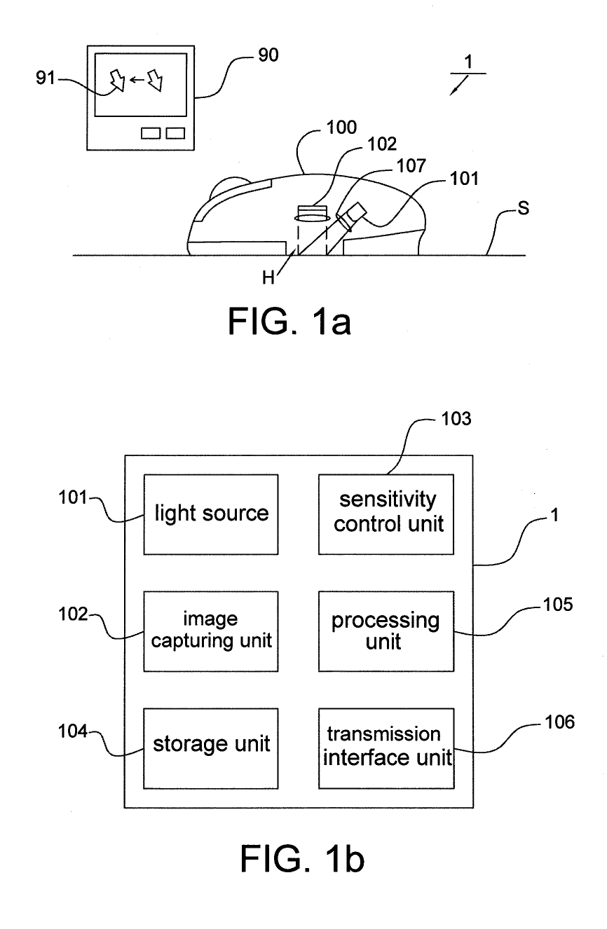

Referring to FIGS. 1a and 1b, they respectively show a schematic diagram and a block diagram of the displacement detection apparatus 1 according to an embodiment of the present invention. Embodiments of the displacement detection apparatus 1 include an optical mouse and an optical pointing device. The displacement detection apparatus 1 is for controlling the movement of a cursor (or an aiming point) 91 shown on an image display device 90. Firstly, the displacement detection apparatus 1 is exemplarily illustrated with an optical mouse.

The displacement detection apparatus 1 (an optical mouse herein) generally has a housing 100 with an opening H formed at the bottom surface of the housing 100. Main components of the displacement detection apparatus 1, including a light source 101, an image capturing unit 102, a sensitivity control unit 103, a storage unit 104, a processing unit 105, a transmission interface unit 106 and at lease one lens (or lens set) 107, are disposed inside the housing 100. The displacement detection apparatus 1 is disposed on a surface S, e.g. the surface of a table or a mouse pad, for being operated by a user (not shown).

Embodiments of the light source 101 include, but not limited to, a light emitting diode and a laser diode, and the light source 101 illuminates the surface S through the opening H under the housing 100 so as to provide the needed light of the image capturing unit 102 for capturing images. It should be emphasized that, when the displacement detection apparatus 1 is an optical mouse, the light source 101 can be included in the optical mouse; however, when the displacement detection apparatus 1 is not an optical mouse, e.g. an optical pointing device, the light source 101 may be omitted.

The image capturing unit 102 captures a plurality of images reflected from the surface S through the opening H, and accordingly calculates an displacement variation of the displacement detection apparatus 1 with respect to the surface S. The sensitivity control unit 103 is for adjusting the displacement sensitivity (CPI) outputted from the displacement detection apparatus 1. The storage unit 104 stores at least one threshold value or a lookup table, wherein the threshold value is served as the reference for adjusting the displacement sensitivity; the lookup table is formed according to the relationship between a plurality of threshold values and desired displacement sensitivity to be outputted from the displacement detection apparatus 1, and the lookup table is set according to the requirement of actual products. The processing unit 105 compares the displacement variation obtained by the image capturing unit 102 with the threshold value stored in the storage unit 104 and adaptively (automatically and real-timely) adjusts the displacement sensitivity outputted from the displacement detection apparatus 1 according to a comparison result of comparing the displacement variation and the threshold value. The transmission interface unit 106 electrically or wirelessly transmits the desired displacement sensitivity outputted by the displacement detection apparatus 1 to an image display device 90, e.g. a television, a computer screen, a game machine screen or a projection screen, so as to accordingly control the movement of a cursor (or an aiming point) 91 shown on the screen of the image display device 90. When the displacement sensitivity is adjusted to be higher, the cursor 91 has higher moving speed; on the other hand, when the displacement sensitivity is adjusted to be lower, the cursor 91 has lower moving speed. It should be understood that, the displacement variation is not limited to be calculated by the image processing unit 102, and it also can be calculated by the processing unit 105.

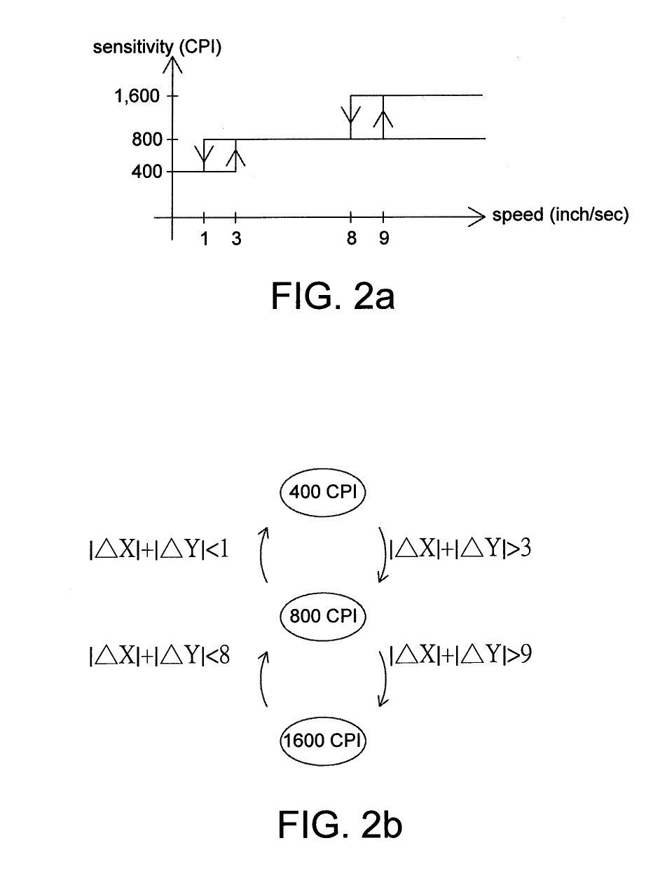

Referring to FIG. 2a, it shows a schematic diagram of the setting of the displacement sensitivity to be outputted by the displacement detection apparatus 1 and threshold values in the displacement detection apparatus 1 according to the embodiment of the present invention, wherein the transverse axis denotes threshold values stored in the storage unit 104 with the unit of inch/sec, while the longitudinal axis denotes the displacement sensitivity (CPI) to be outputted from the displacement detection apparatus 1. As shown in FIG. 2a, four threshold values, including two rising thresholds (3 inches/sec and 9 inches/sec) and two falling thresholds (1 inch/sec and 8 inches/sec) are stored in the storage unit 104, and the values of the rising thresholds are set to be higher than that of the falling thresholds herein. However, the present invention is not limited to this embodiment. In addition, the displacement detection apparatus 1 can output, for example, three displacement sensitivities, e.g. 400 CPI, 800 CPI and 1,600 CPI.

Based on the setting shown in FIG. 2a, the operation of the displacement detection apparatus 1 will be illustrated hereinafter. When the displacement detection apparatus 1 outputs 400 CPI displacement sensitivity and the processing unit 105 determines that the displacement variation obtained by the image capturing unit 102 is smaller than 3 inches/sec, the processing unit 105 informs the sensitivity control unit 103 to control the displacement detection apparatus 1 to maintain the output of 400 CPI displacement sensitivity; on the contrary, when the displacement variation is larger than 3 inches/sec or 9 inches/sec, the processing unit 105 informs the sensitivity control unit 103 to control the displacement detection apparatus 1 to output 800 CPI or 1,600 CPI displacement sensitivity. When the displacement detection apparatus 1 outputs 800 CPI displacement sensitivity and the processing unit 105 determines that the displacement variation obtained by the image capturing unit 102 is smaller than 1 inch/sec, the processing unit 105 informs the sensitivity control unit 103 to control the displacement detection apparatus 1 to output 400 CPI displacement sensitivity. On the other hand, when the displacement variation is larger than 9 inches/sec, the processing unit 105 informs the sensitivity control unit 103 to control the displacement detection apparatus 1 to output 1,600 CPI displacement sensitivity, otherwise maintaining the output of 800 CPI displacement sensitivity. When the displacement detection apparatus 1 outputs 1,600 CPI displacement sensitivity and the processing unit 105 determines that the displacement variation obtained by the image capturing unit 102 is smaller than 1 inch/sec or 8 inches/sec, the processing unit 105 informs the sensitivity control unit 103 to control the displacement detection apparatus 1 to respectively output 400 CPI or 800 CPI displacement sensitivity, otherwise maintaining the output of 1,600 CPI displacement sensitivity. In this embodiment, the rising thresholds are set to be different from the falling thresholds, and this is due to the fact that when the displacement variation obtained by the image capturing unit 102 is very close to one threshold value, it is able to prevent the displacement sensitivity outputted from the displacement detection apparatus 1 from oscillating between two values. In this manner, the stability of the apparatus can be increased. However, the rising thresholds can also be set to be identical to or lower than the falling thresholds, and the setting of threshold values are not limited to those shown in FIG. 2a. In this manner, it is able to adaptively adjust the displacement sensitivity outputted from the displacement detection apparatus 1 so as to fulfill the requirements of various users and increase the practicability of the displacement detection apparatus 1.

Referring to FIG. 2b, it shows another embodiment of the relationship between the displacement variation obtained by the image capturing unit 102 and threshold values as shown in FIG. 2a, wherein the displacement variation consists of a transverse displacement variation ΔX and a longitudinal displacement variation ΔY, and the displacement variation is set as a sum of the absolute value of the transverse displacement variation and the absolute value of the longitudinal displacement variation, i.e. |ΔX|+|ΔY|. In this embodiment, the processing unit 105 compares the displacement variation |ΔX|+|ΔY| obtained by the image capturing unit 102 with the threshold value, for example including two rising thresholds 3 inches/sec, 9 inches/sec and two falling thresholds 1 inch/sec, 8 inches/sec, and informs the sensitivity control unit 103 to control the displacement sensitivity outputted from the displacement detection apparatus 1 according to the comparison result. The adjusting method is similar to that shown in FIG. 2a and thus details will not be illustrated herein. In addition, the displacement variation obtained by the image capturing unit 102 is not limited to the expression shown in FIG. 2b, and it can be represented by the expression of, for example, (ΔX²+ΔY²)^{1/2} or other expressions. The scope of the present invention is that, comparing the displacement variation obtained by the image capturing unit 102 with at least one threshold value and the comparison result is served as a reference for the sensitivity control unit 103 to control the displacement sensitivity (CPI) outputted from the displacement detection apparatus 1. The present invention is not limited to the expression of the displacement itself. In addition, it should be understood that, threshold values and the number of threshold values shown in FIGS. 2a and 2b are only exemplary embodiments and are not used to limit the present invention.

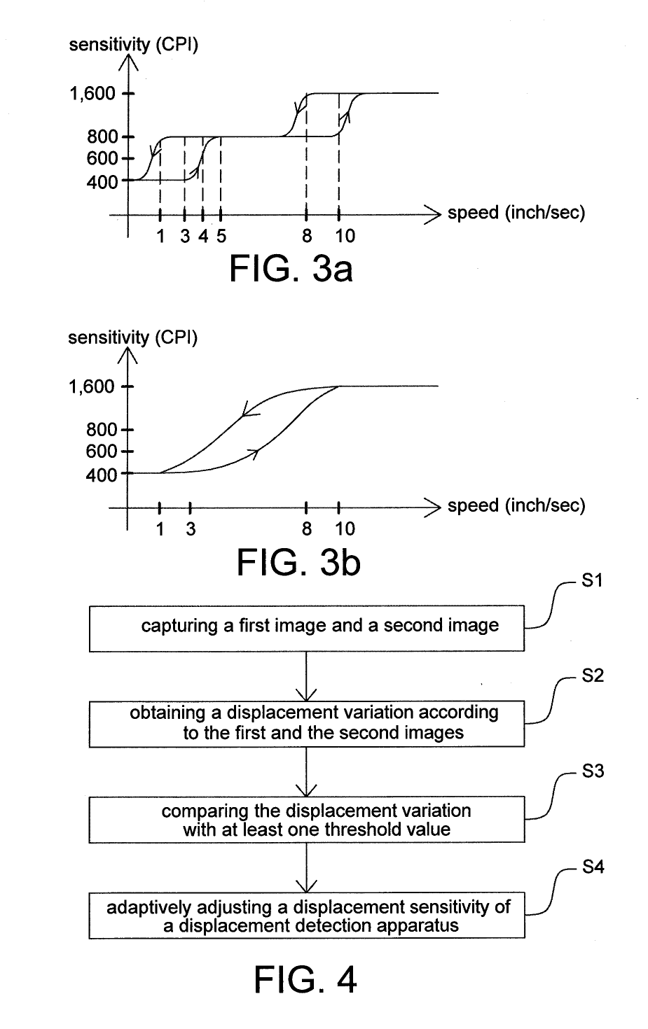

Referring to FIGS. 3a and 3b, they respectively show an alternative embodiment of the setting of the displacement variation obtained by the image capturing unit 102 and threshold values in the displacement detection apparatus 1 of the present invention, wherein a plurality of threshold values and their corresponding displacement sensitivities can be formed as a lookup table or a relationship diagram. For illustrative convenience herein, the relation between a plurality of threshold values and displacement sensitivities is drawn as a relationship diagram and shown in FIGS. 3a and 3b. The processing unit 105 checks the lookup table or the relationship diagram and informs the sensitivity control unit 103 to control the displacement sensitivity outputted from the displacement detection apparatus 1. For example, in FIG. 3a, when the displacement detection apparatus 1 outputs 400 CPI displacement sensitivity and the processing unit 105 determines that the displacement variation obtained by the image capturing unit 102 is larger than 3 inches/sec, the processing unit 105 informs the sensitivity control unit 103 to automatically control the displacement detection apparatus 1 to output different displacement sensitivity under different displacement variation. As an example, when the displacement variation is larger than 4 inches/sec, the displacement sensitivity may be set as 600 CPI. It can be understood that, the number of threshold values and the relation between threshold values and the displacement sensitivity can be set arbitrarily according to actual requirement so as to increase the operational efficiency and practicability at the same time. In addition, as shown in FIG. 3b, in the relationship curve of the displacement sensitivity and the threshold value, the rising curve may be set to be different from the falling curve so as to prevent the displacement sensitivity from oscillating between two values when the displacement variation obtained by the image capturing unit 102 is very close to one threshold value. It can be understood that, in FIGS. 3a and 3b, the expression of the detected displacement variation can also be expressed by other expressions, e.g. (ΔX²+ΔY²)^{1/2} or |ΔX|+|ΔY|.

Referring to FIG. 4, it shows a flow chart of the displacement detection method according to an embodiment of the present invention. The method includes the steps of: capturing a first image and a second image (step S1); obtaining a displacement variation according to the first and the second images (step S2); comparing the displacement variation with at least one threshold value (step S3); and adaptively adjusting a displacement sensitivity outputted from a displacement detection apparatus (step S4).

Firstly, the image capturing unit 102 captures a plurality of images, e.g. a first image and a second image, reflected from the surface S at different time intervals (step S1). Then, the image capturing unit 102 calculates a displacement variation according to the first and the second images (step S2). The processing unit 105 compares the displacement variation with at least one threshold value (step S3), and informs the sensitivity control unit 103 to control the displacement sensitivity outputted from the displacement detection apparatus 1 according to a predetermined lookup table or relationship diagrams shown in FIGS. 2a to 3b (step S4). Finally, the displacement sensitivity will be transmitted to the image display device 90 through the transmission interface unit 106 so as to accordingly control the movement of a cursor or an aiming point 91 shown on the screen of the image display device 90.

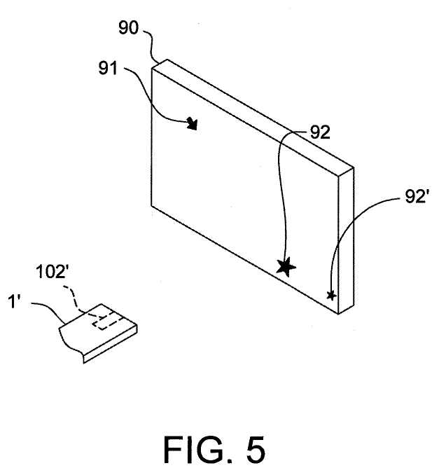

Referring to FIG. 5, it shows an alternative embodiment of the present invention, wherein the displacement detection apparatus 1′ is shown as an optical pointing device. In this embodiment, the image display device 90 preferably further includes, for example, two reference points 92 and 92′. The two reference points may be two light sources 92 and 92′, e.g. light emitting diodes, disposed at the front panel of the image display device 90 or two predetermined icons directly shown on the screen of the image display device 90. The displacement detection apparatus 1′ (optical pointing device herein) captures light emitted from the reference points 92 and 92′ through an image capturing unit 102′ to form a plurality of images, and calculates a displacement variation of the images of the reference points 92 and 92′. In addition, the displacement detection apparatus 1′ also includes a sensitivity control unit for adjusting a displacement sensitivity outputted from the displacement detection apparatus 1′; a storage unit for storing at least one threshold value or a lookup table; a processing unit for comparing the displacement variation obtained by the image capturing unit 102′ with the threshold value stored in the storage unit and for adaptively (automatically and real-timely) adjusting the displacement sensitivity outputted from the displacement detection apparatus 1′ according to a comparison result of comparing the displacement variation and the threshold value; and a transmission interface unit for electrically or wirelessly transmitting the displacement sensitivity outputted from the displacement detection apparatus 1′ to the image display device 90. The procedures which are held after the detected displacement variation was calculated are similar to the displacement detection apparatus 1 and thus details will not be illustrated herein.

It could be understood that the displacement detection method of the present invention is not limited to the embodiments given above. The present displacement detection method also can be adapted to other cursor control or aiming point control, e.g. the aiming point control in a light gun game. That is, any control apparatus which can control a cursor or an aiming point according to an obtained relative displacement between a detection apparatus and a reference object is not departed from the spirit of the present invention.

As already mentioned above, because the conventional displacement detection apparatus can not automatically and real-timely adjust output sensitivity according to operating statuses during operation, it has the problem of unable to fulfill the requirements of various users. The present invention provides a displacement detection apparatus and method (as shown in FIGS. 1a, 1b and 4) which can automatically and real-timely control the displacement sensitivity of a displacement detection apparatus according to a detected displacement variation so as to effectively increase the operational accuracy and practicability.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A displacement detection method, comprising the steps of:
capturing a first image and a second image, and obtaining a displacement variation according to the first and the second images;
comparing the displacement variation with at least one threshold value; and
adaptively adjusting a displacement sensitivity outputted from a displacement detection apparatus according to a comparison result of comparing the displacement variation with the threshold value.

2. The displacement detection method as claimed in claim 1, further comprising the step of:
transmitting the displacement sensitivity to an image display device to accordingly control the movement of a cursor or an aiming point shown on the image display device.

3. The displacement detection method as claimed in claim 1, wherein the displacement sensitivity comprises a first sensitivity and a second sensitivity higher than the first sensitivity, and the step of adjusting a displacement sensitivity outputted from a displacement detection apparatus further comprises:
outputting the first sensitivity from the displacement detection apparatus when the displacement variation is smaller than the threshold value; and
outputting the second sensitivity from the displacement detection apparatus when the displacement variation is larger than the threshold value.

4. The displacement detection method as claimed in claim 1, wherein the displacement sensitivity comprises a first sensitivity and a second sensitivity higher than the first sensitivity, and the threshold value comprises a rising threshold and a falling threshold lower than the rising threshold, and when the displacement detection apparatus outputs the first sensitivity, the step of adjusting a displacement sensitivity outputted from a displacement detection apparatus further comprises:
outputting the second sensitivity from the displacement detection apparatus when the displacement variation is larger than the rising threshold; and
outputting the first sensitivity from the displacement detection apparatus when the displacement variation is smaller than the rising threshold.

5. The displacement detection method as claimed in claim 1, wherein the displacement sensitivity comprises a first sensitivity and a second sensitivity higher than the first sensitivity, and the threshold value comprises a rising threshold and a falling threshold lower than the rising threshold, and when the displacement detection apparatus outputs the second sensitivity, the step of adjusting a displacement sensitivity outputted from a displacement detection apparatus further comprises:
outputting the second sensitivity from the displacement detection apparatus when the displacement variation is larger than the falling threshold; and
outputting the first sensitivity from the displacement detection apparatus when the displacement variation is smaller than the falling threshold.

6. The displacement detection method as claimed in claim 1, wherein the displacement variation is a sum of the absolute value of a transverse displacement variation and the absolute value of a longitudinal displacement variation.

7. A displacement detection method for adaptively adjusting a displacement sensitivity outputted from a displacement detection apparatus, comprising the steps of:
providing a lookup table representing the relationship between a plurality of threshold values and the displacement sensitivity to be outputted from the displacement detection apparatus;
capturing a first image and a second image, and obtaining a displacement variation according to the first and the second images; and
comparing the displacement variation with the lookup table to adaptively adjust the displacement sensitivity outputted from the displacement detection apparatus.

8. The displacement detection method as claimed in claim 7, further comprising the step of:
transmitting the displacement sensitivity to an image display device to accordingly control the movement of a cursor or an aiming point shown on the image display device.

9. The displacement detection method as claimed in claim 7, wherein the lookup table is drawn as a relationship diagram of the threshold values and the displacement sensitivity to be outputted from the displacement detection apparatus.

10. A displacement detection apparatus, comprising:
an image capturing unit for capturing a first image and a second image and for obtaining a displacement variation according to the first and the second images;
a storage unit storing at least one threshold value;
a sensitivity control unit for adjusting a displacement sensitivity outputted from the displacement detection apparatus; and
a processing unit for comparing the displacement variation with the threshold value and for adaptively controlling the sensitivity control unit to adjust the displacement sensitivity outputted from the displacement detection apparatus according to a comparison result of comparing the displacement variation with the threshold value.

11. The displacement detection apparatus as claimed in claim 10, further comprising a transmission interface unit for transmitting the displacement sensitivity outputted from the displacement detection apparatus to an image display device.

12. The displacement detection apparatus as claimed in claim 11, wherein the image display device is selected from the group consisting of a television, a computer screen, a game machine screen and a projection screen.

13. The displacement detection apparatus as claimed in claim 11, wherein the displacement detection apparatus is electrically or wirelessly coupled to the image display device.

14. The displacement detection apparatus as claimed in claim 10, wherein the displacement detection apparatus is an optical mouse or an optical pointing device.

15. The displacement detection apparatus as claimed in claim 10, wherein a plurality of threshold values are stored in the storage unit and each of the threshold value is corresponded to one displacement sensitivity, wherein the threshold values and the displacement sensitivities form a lookup table.

16. The displacement detection apparatus as claimed in claim 10, wherein a plurality of threshold values are stored in the storage unit and each of the threshold value is corresponded to one displacement sensitivity, wherein the threshold values and the displacement sensitivities form a relationship diagram.
